(19) United States
(12) Patent Application Publication
(10) Pub. No.: US 2015/0030731 A1
(43) Pub. Date: Jan. 29, 2015

(54) METHOD AND APPARATUS FOR MARKING COCONUTS AND SIMILAR FOOD PRODUCTS

(71) Applicant: The Coconut Cartel LLC, Miami Beach, FL (US)

(72) Inventor: Michael S. Zighelboim, Miami Beach, FL (US)

(21) Appl. No.: 14/331,953

(22) Filed: Jul. 15, 2014

Related U.S. Application Data
(63) Continuation-in-part of application No. 29/461,574, filed on Jul. 24, 2013.

(51) Int. Cl. A23L 1/025; A23L 1/212; B41J 2/44

(52) U.S. Cl. CPC A23L 1/0252; B41J 2/442; A23L 1/2123; A23V 2002/00
USPC 426/241; 347/224

(57) ABSTRACT

A method of marking a product such as a coconut includes providing a laser light emitter configured to produce powered laser light having a user-specified spectrum and intensity. A bracket base is provided that includes a workframe interface configured to stabilize the bracket relative to a workframe, and the bracket base defines at least one receiving socket sized to stabilize at least a portion of the food product relative to the bracket base. Programmable controllers trigger the laser light emitter and manipulates at least one servomotor to burn at least a portion of the graphical mark at least partially onto a surface of the food product in accordance with graphics-related data. An apparatus is also disclosed.

### PRIORITY CLAIM

The present application is a continuation-in-part of and incorporates herein by reference U.S. patent application Ser. No. 29/461,574, filed on Jul. 24, 2013.

### BACKGROUND

1. Technical Field

The present disclosure relates to the field of food processing. In particular, the present disclosure relates to a method and apparatus for marking a food product, such as a coconut, with a desired marking such as a logo or a symbol.

2. Background Information

Packaged food products that are mass-marketed to consumers are often marked on their packaging with graphical logos to denote brand. Other information, such as use instructions, nutritional information and other items may be printed on such packaging using conventional printing processes, such as offset printing, stamping, and inkjet printing.

It is difficult, however, to provide labeling and branding on products that are not artificially packaged. For example, produce, such as fruit and vegetables, are often rendered undesirable or may be prone to premature spoilage if they are packaged in containers.

For some produce products, such as bananas, apples and watermelons, the natural skin or peel of the product itself provides a smooth surface on which a sticker label may be placed. In some cases, light inkjet printing may allow for the deposition of a brand marking or other information directly on the peel. The marking for these products is usually subtle and relatively small, so as to not damage the produce or otherwise render it undesirable by the consumer.

With the advent of specialized produce products, such as coconut water, the consumer is typically drawn to the freshest products possible. As an alternative to providing packaged coconut water in bottles and cartons, it is desirable to provide coconut water directly to consumers while still contained within the coconut. It is difficult to provide branded whole coconuts to consumers, however. The whole coconut must be wrapped in packaging in order to affix branding due to the rough and non-homogenous nature of a typical fibrous coconut husk, or fibrous portions of the husk that may remain on the shell in “husked” coconuts.

As noted above, the artificial packaging of coconuts may reduce their shelf life, and also alter flavor and general consumer desirability. While the shell of a coconut is often considered tough and durable, for a fresh coconut that contains coconut water, the outer surface is actually porous and easily damaged by printing or other processes that might inflict trauma to the surface. Such damage can easily compromise the integrity of the coconut water inside, as well as decrease its shelf life. Thus, an improved method of marking and branding produce such as coconuts is needed.

### BRIEF SUMMARY

To provide a convenient method of marking a food product with a graphical mark, steps are provided herein in a first of the present embodiments. The method includes providing a laser light emitter configured to produce powered laser light having a user-specified spectrum and intensity. A workframe is placed at a user-defined distance from the laser light emitter to receive the laser light, and a bracket base is positioned over the workframe. The bracket base includes a workframe interface configured to stabilize the bracket relative to the workframe, and the bracket base defines at least one receiving socket sized to stabilize at least a portion of the food product relative to the bracket base. Subsequently, a product, such as a coconut, is positioned on the receiving socket. A user interface includes a graphical display for defining the graphical mark, and data is stored relating to the graphical mark in at least one computer memory. A first programmable controller is also provided for triggering intermittently the laser light emitter in a pre-programmed sequence in accordance with the stored data.

The method also includes providing at least one servomotor for moving at least one of the workframe and the laser light emitter in accordance with the data, manipulating at least one of the base, the laser light emitter and the workframe to position the product relative to the laser light emitter. The first programmable controller triggers the laser light emitter and manipulates the at least one servomotor to burn at least a portion of the graphical mark at least partially onto a surface of the food product in accordance with the data.

Another embodiment is disclosed relating to a method of marking a coconut husk with a user-defined graphical mark. In this method, a laser light emitter is configured to produce powered laser light having a user-specified spectrum and intensity. A bracket base is positioned over the workframe. The bracket base includes a workframe interface configured to stabilize the bracket relative to the workframe, and the bracket base defines at least one receiving socket sized to stabilize the coconut relative to the bracket base. A coconut of substantially pre-determined size and shape is then positioned on the bracket base wherein at least a portion of the coconut is held within the socket. At least one of the laser light emitter and the bracket base are then manipulated in a user-defined sequence and path to mark the shell to a pre-defined depth within the shell.

A third embodiment is disclosed comprising an apparatus for marking a food product with a graphical mark. The apparatus comprises a laser light emitter configured to produce powered laser light having a user-specified spectrum and intensity, a workframe positioned to receive the laser light from the laser light emitter, and a bracket base positioned over the workframe. The bracket base includes a workframe interface configured to stabilize the bracket relative to the workframe, and the bracket base defines at least one receiving socket sized to stabilize at least a portion of the food product relative to the bracket base.

A first controller is provided in communication with the laser light emitter and is configured to trigger intermittently the laser light emitter in a pre-programmed sequence. The apparatus further includes a user interface in communication with the first controller, at least one digital processor in communication with the first controller for producing data relating to the graphical mark, and at least one computer memory in communication with the user interface for storing data relating to the graphical mark. The apparatus also includes a second controller in communication with the at least one digital processor and at least one servomotor positioned to move at least one of the workframe and the laser light emitter in accordance with commands issued by the second controller. The first and second controllers are operable to trigger the laser light emitter and the at least one servomotor to burn at least a portion of the graphical mark at least partially onto a surface of the food product in accordance with the data.

A fourth embodiment is disclosed comprising a method of marking a food product with a graphical mark. The method includes the steps of providing a laser light emitter configured to produce powered laser light having a user-specified spectrum and intensity and stabilizing a product a user-defined distance from said laser light emitter to receive said laser light. A user interface is provided that includes a graphical display for defining the graphical mark. Date is stored relating to the graphical mark in at least one computer memory and a first programmable controller is provided for triggering intermittently said laser light emitter in a pre-programmed sequence in accordance with the data relating to said graphical mark. At least one servomotor moves the laser light emitter in accordance with the data and manipulates the laser light emitter such that the laser light emitter is positioned a pre-defined distance from the product. The first programmable controller is activated to trigger the laser light emitter and the at least one servomotor is manipulated to burn at least a portion of the graphical mark at least partially onto a surface of the food product in accordance with the data.

A fifth embodiment is disclosed comprising an apparatus for marking a food product with a graphical mark. The apparatus comprises a laser light emitter configured to produce powered laser light having a user-specified spectrum and intensity, a workframe positioned to receive the laser light from the laser light emitter, a bracket base positioned over the workframe, the bracket base including a workframe interface configured to stabilize the bracket relative to the workframe, and the bracket base defining at least one receiving socket sized to stabilize at least a portion of the food product relative to the bracket base. The apparatus also includes a first controller in communication with the laser light emitter, and the controller is configured to trigger intermittently the laser light emitter. A user interface is in communication with the first controller and includes a graphical display for defining the graphical mark and at least one digital processor is in communication with the first controller for producing data relating to the graphical mark. At least one computer memory is in communication with the user interface for storing data relating to said graphical mark and a second controller is in communication with at least one digital processor. At least one servomotor is positioned to move at least one of the workframe and the laser light emitter in accordance with commands issued by the second controller. The first and second controllers are operable to trigger the laser light emitter and the at least one servomotor to burn at least a portion of the graphical mark at least partially onto a surface of the food product in accordance with the data.

These and other features and advantages of the invention will become apparent upon the review of the following detailed description of the presently preferred embodiments of the invention, taken in conjunction with the appended figures.

### BRIEF DESCRIPTION OF THE DRAWINGS

FIG. 1 illustrates a produce product including a graphical mark;

FIG. 2 is a schematic view of a system in accordance with a first embodiment of the present invention;

FIG. 3 is a planar view of a portion of the first embodiment of FIG. 2 showing the workframe and other mechanical portions of the apparatus; and

FIG. 4 is a flow diagram illustrating a method in accordance with a second embodiment of the present invention.

### DETAILED DESCRIPTION OF THE DRAWINGS AND THE PRESENTLY PREFERRED EMBODIMENTS

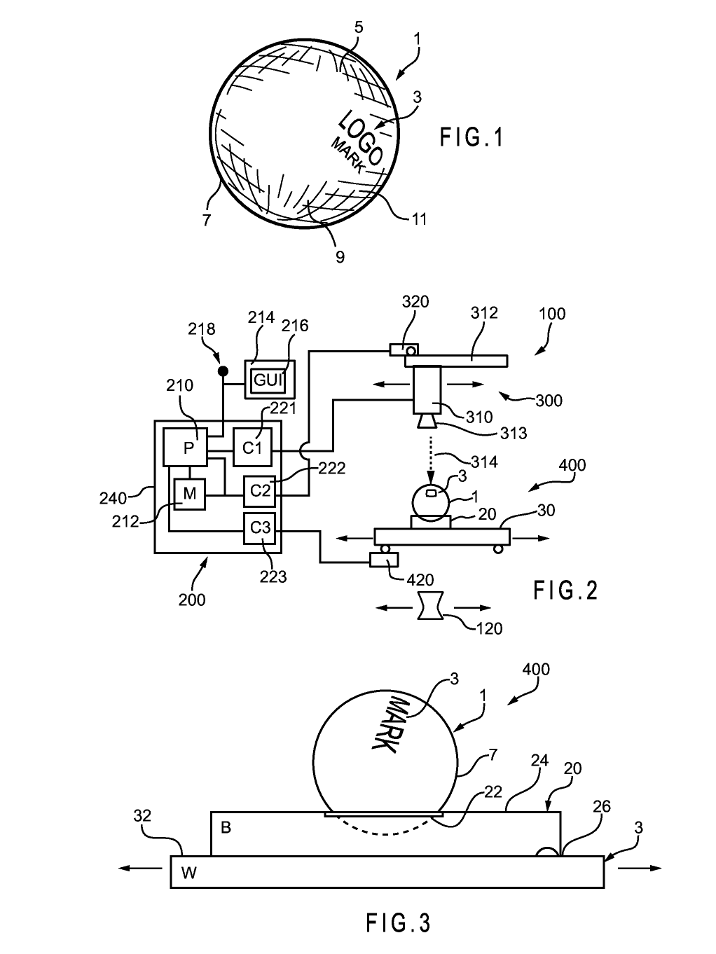

The present method and apparatus have been determined to be the best way to deposit a print or other mark onto the shell of a fresh, “husked” coconut without inflicting trauma to the coconut's contents. FIG. 1 is a perspective illustration of a food product, specifically a coconut 1, including a graphical design element or mark 3 printed on the outer surface 5 of its shell 7. The coconut 1 is defined by a generally spherical shape having a very rough outer shell 9 that further defines the outer surface 5. For purposes of the present disclosure, the term “husked” refers to a coconut having at least a portion of the husk removed from the shell so that some of the fibers from the removed husk remain on the shell. The shell 9 includes various fiber elements 11 of the removed husk portion of the coconut loosely positioned on the surface 5, and thus for purposes of this disclosure the term “shell” is intended to refer to the hard shell of the coconut including fiber elements 11 from the removed husk that may remain on the surface. In the preferred embodiment, the mark 3 is printed using a laser beam that burns the logo onto the surface 5 of the shell 7. For purposes of the present embodiment, a young cocos nucifera coconut from the El Salvador region has been shown to be acceptable.

The printing using the method and apparatus herein have been found to provide a readable, long-lasting and non-damaging mark in an efficient and time-saving fashion. This method and apparatus are suitable for commercialization, mass production and even portability.

The apparatus used for this type of printing and its associated methods of use are described further below.

FIGS. 2 and 3 illustrate portions of the apparatus that holds the coconut 1 in place in varying detail. As shown in the enlarged illustration of FIG. 3, the coconut manipulation subsystem 400 holds the coconut 1 in place by the base bracket 20. The bracket base 20 is, in this embodiment, made from thick acrylic, and defines generally at its center a round opening 22 that acts as a socket. The opening 22 is sized to be between 3 and 4 inches, and it allows for the coconut 1 to be held in place as a portion of the coconut's outer surface 7 is held within the opening 22. The bottom surface of the bracket base 20 allows it to interface with the top surface 32 of a workframe 30. The workframe 30 may be a rack or a table that may or may not be movable in accordance with commands from a controller. The workframe 30 and the bracket base 20 together cooperate to position the coconut 1 beneath a laser emitter 120.

The system diagram of FIG. 2 illustrates schematically various other componentry that controls the movement of a laser beam from the laser emitter 120 relative to the surface 7 of the coconut 1. The main system 100 generally includes an electronic controller subsystem 200, a laser emitter subsystem 300, and the coconut manipulation subsystem 400 described above.

The electronic controller subsystem 200 comprises at least one microprocessor 210 that is connectable to one or more computer memory devices 212. The microprocessor 210 communicates with a graphical user interface 214 that includes a display 216. An input, such as a USB port, disk drive, or network connection is provided at 218 for receiving data, such as software updates, graphics files from external sources, or remote commands. The microprocessor 210 may issue instructions to a first controller 221, a second controller 222 and a third controller 223, which in turn communicate with various servomotors in the coconut manipulator subsystem 400 and the laser emitter subsystem 300. The electronic controller subsystem may comprise a portion of or an entirety of a personal computer device such as a laptop or desktop PC, and may be housed within a single housing 240.

The laser emitter subsystem 300 includes a laser emitter 310 mounted on a frame or arm 312. The laser emitter 310 may be, for example, a type-2 CO2 laser manufactured by Trotec emitting a laser beam 314 of 0.1 mm focal diameter, which converts to an approximate 8 mm beam width after collimation through the in-machine emitter lens 313. In the present embodiment of the laser emitter 310, the frequency range is 1 Khz-140 Khz, and the spectrum is 9-11 μm. The main emission line is at 10.6 μm. The arm 312 may be moved in various directions by one or more servomotors 320 which are in communication with the controller 222 in the subsystem 200. In the preferred embodiment, the laser emitter 310 is positioned directly above the workframe 30, the bracket base 20 and the coconut 1 as shown in FIGS. 2 and 3. When performing the method below, the position of the laser 310 is moved by the controller C1 while the position of the coconut remains stationary. Such a configuration is only exemplary, and other relative movement between the laser emitter 310 and the coconut 1 may be achieved through other servomotor configurations. Of course, other laser manufacturers and types may be implemented along with machinery to accomplish the present invention.

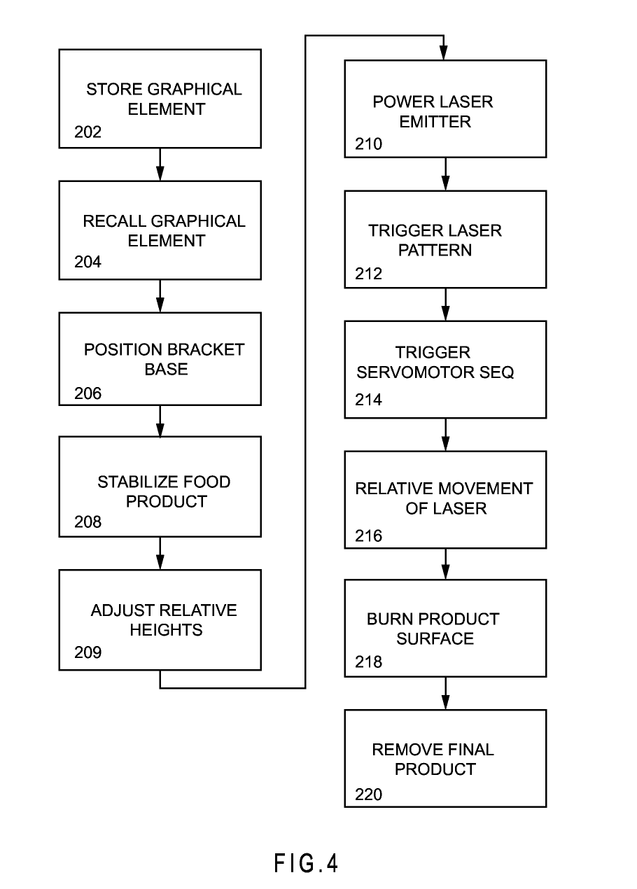

FIG. 4 is a flowchart showing the embodiments of methods for marking a food product with a graphical mark. Prior to beginning the process, the user may design a mark through a conventional graphics program, such as Adobe Photoshop®, Illustrator®, or InDesign®. Alternately, the user may scan a mark or design using these programs or others. The mark graphics may be provided in a vector format, such as an .eps or .ai (Adobe Illustrator®) file, or in a format such as a JPEG or GIF file.

Beginning with step 202 in FIG. 4, the user stores the corresponding graphics file including its associated data for the mark 3 into the system 20, specifically within memory 212. (Prior to this step, the user may design a mark 3 to be printed onto the coconut 1). Marks of various kinds and types, such as trademarks, brands, symbols, or even plain text, may be programmed into the system via the user interface 214.

At step 204, the user then retrieves the logo from the computer memory of the system 20. At 206, the user positions the bracket base 20 underneath the laser emitter 310. At 208, the user aligns the coconut 1 with the socket opening 22 of the base 20, and mounts the coconut 1 within the base 20. The coconut 1 may need to be adjusted for the most stable position on base 20. The user may need to further adjust the height of the laser emitter 310 relative to the surface 7 of the coconut 1 by either adjusting the height of the workframe 30, the elevation of the base 20, the orientation and position of the coconut 1, or by adjusting the height of the laser emitter 310. These adjustments are shown at 209.

The user then powers on the laser emitter at step 210, and activates the computer processor 210 which in turn activates the laser emitter controller 221 to emit a pre-determined laser pattern sequence at 212. In the preferred embodiment, the laser emits pulses in the range of 500-1000 pulses per inch (PPI). The servomotor controllers 222 and 223 are also activated by the processor 210 as necessary. In the present embodiment, at least one servomotor may be part of a mechanical manipulating arm for positioning the laser emitter 310. In the present embodiment the servomotor arm system is manufactured by Trotec under the InPack Technologies trademark.

At 214, the servomotors 320 and 420 are in turn activated by signals from the servomotors 222 and 223, resulting in movement of the workframe 30, the laser emitter 310, or both relative to each other to cause the laser beam 314 to move in a pre-determined path. At 218, the laser beam in turn burns the coconut shell 9 and outer surface 7 of the coconut 1 in a corresponding path the pre-determined path and thereby marks the coconut 1 with the mark 3. Finally, the imprinted coconut 1 is removed at 220 once the controller sequence has finished sufficiently to render the logo.

It should be noted that various graphics and controller interfaces are available for translating the logo graphics file to a commands suitable to operate the controller and in turn the servomotors. Furthermore, the design that is burned onto the food product could result from a pre-programmed sequence or could be manually controlled by a user using a user control interface such as a control stick or other interfaces as known in the art.

Of course, it should be understood that a wide range of changes and modifications can be made to the embodiment of the method described above. It is therefore intended that the foregoing detailed description be regarded as illustrative rather than limiting and that it be understood that it is the following claims, including all equivalents, which are intended to define the scope of this invention.

1. A method of marking a food product with a graphical mark, said method comprising the steps of:
providing a laser light emitter configured to produce powered laser light having a user-specified spectrum and intensity;
positioning a workframe at a user-defined distance from said laser light emitter to receive said laser light;
positioning a bracket base over said workframe, said bracket base including a workframe interface configured to stabilize said bracket relative to said workframe, and said bracket base defining at least one receiving socket sized to stabilize at least a portion of said food product relative to said bracket base;
positioning said product at least partially within said receiving socket;
providing a user interface including a graphical display for defining said graphical mark;
storing data relating to said graphical mark in at least one computer memory;
providing a first programmable controller for triggering intermittently said laser light emitter in a pre-programmed sequence in accordance with said data relating to said graphical mark;
providing at least one servomotor for moving at least one of said workframe and said laser light emitter in accordance with said data;
manipulating at least one of said base and said laser light emitter and said workframe to position said product relative to said laser light emitter a pre-defined distance between said laser light emitter and said product; and
activating said first programmable controller to trigger said laser light emitter and manipulating said at least one servomotor to burn at least a portion of said graphical mark at least partially onto a surface of said food product in accordance with said data.

2. The method of marking a food product with a graphical mark in accordance with claim 1, said method further comprising:
providing a second programmable controller for moving the other of said workframe and said laser light emitter in accordance with said data.

3. The method of marking a food product with a graphical mark in accordance with claim 1 wherein said bracket base defines a top surface and said socket further comprises an opening defined in said top surface.

4. The method of marking a food product with a graphical mark in accordance with claim 3 wherein said opening further comprises an adjustable clamp for grasping said food product.

5. The method of marking a food product with a graphical mark in accordance with claim 3 wherein said product is generally spherical in shape.

6. The method of marking a food product with a graphical mark in accordance with claim 5 wherein said product further comprises a coconut having a shell, and said mark is burned into at least a portion of said shell.

7. The method of marking a food product with a graphical mark in accordance with claim 2 wherein said laser light emitter further comprises a type-2 CO2 laser having at least an 8 mm diameter beam width within a spectrum of between about 9-11 μm.

8. The method of marking a food product with a graphical mark in accordance with claim 7 wherein said laser light emitter is timed to issue bursts of laser light of between approximately 500 and 1000 pulses per inch (PPI).

9. The method of marking a food product with a graphical mark in accordance with claim 8 wherein said graphical mark further comprises a sequence of burns issued from said laser light emitter into the shell of a coconut.

10. The method of marking a food product with a graphical mark in accordance with claim 1 wherein said bracket base is positioned opposite said workframe interface.

11. The method of marking a food product with a graphical mark in accordance with claim 10 wherein said laser light emitter is connected to a first of said at least one servomotor to move said laser light emitter relative to said workframe.

12. The method of marking a food product with a graphical mark in accordance with claim 10 wherein said at least one servomotor is configured to move said workframe relative to said laser light emitter.

13. The method of marking a food product with a graphical mark in accordance with claim 10 wherein said laser light emitter is connected to a first of said at least one servomotor and further comprising a second servomotor to move said workframe, wherein said first and second servomotors cooperate to produce said graphical mark in accordance with said data.

14. A method of marking a coconut shell with a user-defined graphical mark, said method comprising the steps of:
providing a laser light emitter configured to produce powered laser light having a user-specified spectrum and intensity;
positioning a bracket base over said workframe, said bracket base including a workframe interface configured to stabilize said bracket relative to said workframe, and said bracket base defining at least one receiving socket sized to stabilize the coconut relative to said bracket base;
positioning a coconut of substantially pre-determined size and shape on said bracket base wherein at least a portion of said coconut is held within said socket; and
manipulating at least one of said laser light emitter and said bracket base in a user-defined sequence to mark said shell to a pre-defined depth within said shell.

15. The method of marking a coconut shell with a graphical mark in accordance with claim 14, said method further comprising:
providing at least one servomotor for moving at least one of said workframe and said laser light emitter in accordance with commands issued by at least one programmable controller.

16. The method of marking a coconut shell with a graphical mark in accordance with claim 14 wherein said bracket base defines a top surface and said socket further comprises an opening defined in said top surface.

17. The method of marking a coconut shell with a graphical mark in accordance with claim 14 wherein said laser light emitter further comprises a type-2 CO2 laser having at least an 8 mm diameter beam width within a spectrum of between about 9-11 μm.

18. The method of marking a coconut shell with a graphical mark in accordance with claim 17 wherein said laser light emitter is timed to issue bursts of laser light of between approximately 500 and 1000 pulses per inch (PPI).

19. An apparatus for marking a food product with a graphical mark, said apparatus comprising:
a laser light emitter configured to produce powered laser light having a user-specified spectrum and intensity;
a workframe positioned to receive said laser light from said laser light emitter;
a bracket base positioned over said workframe, said bracket base including a workframe interface configured to stabilize said bracket relative to said workframe, and said bracket base defining at least one receiving socket sized to stabilize at least a portion of said food product relative to said bracket base;
a first controller in communication with said laser light emitter, said controller configured to trigger intermittently said laser light emitter in a pre-programmed sequence;
a user interface in communication with said first controller including a graphical display for defining said graphical mark;
at least one digital processor in communication with said first controller for producing data relating to said graphical mark;
at least one computer memory in communication with said user interface for storing data relating to said graphical mark;
a second controller in communication with said at least one digital processor; and
at least one servomotor positioned to move at least one of said workframe and said laser light emitter in accordance with commands issued by said second controller;
wherein said first and second controllers are operable to trigger said laser light emitter and said at least one servomotor to burn at least a portion of said graphical mark at least partially onto a surface of said food product in accordance with said data.

20. The apparatus of claim 19 further comprising a second servomotor to move the other of said workframe and said laser light emitter, wherein said first and second servomotors cooperate to produce said graphical mark in accordance with said data.

21. A method of marking a food product with a graphical mark, said method comprising the steps of:
providing a laser light emitter configured to produce powered laser light having a user-specified spectrum and intensity;
stabilizing a product a user-defined distance from said laser light emitter to receive said laser light;
providing a user interface including a graphical display for defining said graphical mark;
storing data relating to said graphical mark in at least one computer memory;
providing a first programmable controller for triggering intermittently said laser light emitter in a pre-programmed sequence in accordance with said data relating to said graphical mark;
providing at least one servomotor for moving said laser light emitter in accordance with said data;
manipulating said laser light emitter such that said laser light emitter is positioned a pre-defined distance from said product; and
activating said first programmable controller to trigger said laser light emitter and manipulating said at least one servomotor to burn at least a portion of said graphical mark at least partially onto a surface of said food product in accordance with said data.

22. An apparatus for marking a food product with a graphical mark, said apparatus comprising:
a laser light emitter configured to produce powered laser light having a user-specified spectrum and intensity;
a workframe positioned to receive said laser light from said laser light emitter;
a bracket base positioned over said workframe, said bracket base including a workframe interface configured to stabilize said bracket relative to said workframe, and said bracket base defining at least one receiving socket sized to stabilize at least a portion of said food product relative to said bracket base;
a first controller in communication with said laser light emitter, said controller configured to trigger intermittently said laser light emitter;
a user interface in communication with said first controller including a graphical display for defining said graphical mark;
at least one digital processor in communication with said first controller for producing data relating to said graphical mark;
at least one computer memory in communication with said user interface for storing data relating to said graphical mark;
a second controller in communication with said at least one digital processor; and
at least one servomotor positioned to move at least one of said workframe and said laser light emitter in accordance with commands issued by said second controller;
wherein said first and second controllers are operable to trigger said laser light emitter and said at least one servomotor to burn at least a portion of said graphical mark at least partially onto a surface of said food product in accordance with said data.
